(19) United States
(12) Patent Application Publication
(10) Pub. No.: US 2014/0045016 A1
(43) Pub. Date: Feb. 13, 2014

(54) NONAQUEOUS ELECTROLYTE SECONDARY BATTERY

(71) Applicant: SANYO Electric Co., Ltd., Osaka (JP)

(72) Inventors: Eiji Okutani, Kasai-shi (JP); Yoshinori Yokoyama, Itano-gun (JP); Takayuki Hattori, Minamiawaji-shi (JP); Yasuhiro Yamauchi, Sumoto-shi (JP)

(73) Assignee: SANYO ELECTRIC CO., LTD., Osaka (JP)

(21) Appl. No.: 13/961,994

(22) Filed: Aug. 8, 2013

(30) Foreign Application Priority Data
Aug. 9, 2012 (JP) 2012-177269

(51) Int. Cl. H01M 10/056; H01M 10/052

(52) U.S. Cl. CPC H01M 10/056; H01M 10/052
USPC 429/94; 429/185

(57) ABSTRACT

A nonaqueous electrolyte secondary battery according to an embodiment of the invention includes: a flat electrode assembly including a positive electrode and a negative electrode; a bottomed prismatic hollow outer can storing the flat electrode assembly and a nonaqueous electrolyte and having an opening portion; and a sealing plate sealing the opening portion of the hollow outer can. The flat electrode assembly has a portion, other than the side facing the sealing plate, covered with an insulating sheet. The nonaqueous electrolyte contains lithium difluorophosphate (LiPF₂O₂) at the time of making the nonaqueous electrolyte secondary battery. The outer surface area of a battery outer body including the hollow outer can and the sealing plate is 350 cm² or more. This nonaqueous electrolyte secondary battery has excellent output characteristics in a low temperature environment.

### TECHNICAL FIELD

The present invention relates to a nonaqueous electrolyte secondary battery that has excellent output characteristics in a low temperature environment.

Alkaline secondary batteries typified by nickel-hydrogen batteries and nonaqueous electrolyte secondary batteries typified by lithium ion batteries have been widely used as a power supply for driving portable electronic equipment, such as cell phones including smartphones, portable personal computers, PDAs, and portable music players. In addition, alkaline secondary batteries and nonaqueous electrolyte secondary batteries have been widely used as a power supply for driving electric vehicles (EVs) and hybrid electric vehicles (HEVs and PHEVs), and in stationary storage battery systems for suppressing output fluctuation of solar power generation and wind power generation, for example, and for a peak shift of system power that utilizes the power during the daytime while saving the power during the nighttime.

The use of EVs, HEVs, and PHEVs or the stationary storage battery system especially requires high capacity and high output characteristics. The size of each battery is therefore increased, and a plurality of batteries are connected in series or in parallel for use. Therefore, nonaqueous electrolyte secondary batteries have been generally used for these purposes in view of space efficiency. When physical strength is needed, a metal prismatic outer body with one side open, and a metal sealing plate for sealing this opening are generally adopted as an outer can of a battery.

Increasing longevity is essential in nonaqueous electrolyte secondary batteries used for the above-mentioned purposes. Therefore, various additives are added to a nonaqueous electrolyte in order to prevent degradation. For example, Japanese Patent No. 3439085 discloses the invention of a nonaqueous electrolyte secondary battery in which lithium difluorophosphate (LiPF₂O₂) is added to a nonaqueous electrolyte in order to prevent self-discharge at charge storage and improve storage characteristics after charging. JP-A-2007-227367 shows an example in which LiPF₂O₂ is added to a nonaqueous electrolyte in order to obtain a nonaqueous electrolyte secondary battery having excellent cycling characteristics and low-temperature outputs.

JP-A-2009-129541 discloses that a cyclic phosphazene compound and various salts having an oxalate complex as an anion are added to a nonaqueous electrolyte of a nonaqueous electrolyte secondary battery. JP-T-2010-531856 and JP-A-2010-108624 disclose the addition of lithium bis(oxalato)borate (Li[B(C₂O₄)₂], hereinafter referred to as “LiBOB”), which is one of the lithium salts having an oxalate complex as an anion.

In the nonaqueous electrolyte secondary battery disclosed in Japanese Patent No. 3439085, LiPF₂O₂ and lithium are reacted in a nonaqueous electrolyte to form a high-quality protective covering onto an interface of a positive electrode active material and a negative electrode active material. This protective covering prevents direct contact between an active material in a state of charge and an organic solvent, thereby preventing decomposition of the nonaqueous electrolyte due to contact between the active material and the nonaqueous electrolyte. Consequently, an advantageous function effect of improving charge storage characteristics can be attained. In the nonaqueous electrolyte secondary battery disclosed in JP-A-2007-227367, a protective covering formed due to the LiPF₂O₂ brings preferable cycling characteristics and gives an advantageous effect of obtaining a nonaqueous electrolyte secondary battery that has excellent low temperature characteristics.

When a cyclic phosphazene compound and various salts having an oxalate complex as an anion disclosed in JP-A-2009-129541 are added, fire resistance of the nonaqueous electrolyte is improved, which can provide a nonaqueous electrolyte secondary battery having excellent battery characteristics and high safety. When LiBOB disclosed in JP-T-2010-531856 and JP-A-2010-108624 is added to a nonaqueous electrolyte, a protective layer including a lithium ion conductive layer that is thin and extremely stable is formed on the surface of a carbon negative electrode active material of the nonaqueous electrolyte secondary battery. This protective layer is stable even in a high temperature, consequently preventing the carbon negative electrode active material from decomposing the nonaqueous electrolyte. This leads to an advantage of providing excellent cycling characteristics and improving the safety of a battery.

Nonaqueous electrolyte secondary batteries can be used in a low temperature environment since EVs, HEVs, and PHVs are used outside. However, there is the problem that a low temperature environment increases the viscosity of a nonaqueous electrolyte of the nonaqueous electrolyte secondary battery, thereby lowering output characteristics. In particular, nonaqueous electrolyte secondary batteries used for EVs, HEVs, and PHVs, which have high capacity and high output characteristics, employ a large size. However, the large surface area of the battery outer can means that the battery is susceptible to the effect of the external low temperature environment.

### SUMMARY

An advantage of some aspects of the invention is to provide a nonaqueous electrolyte secondary battery that has excellent low temperature output characteristics.

A nonaqueous electrolyte secondary battery according to an aspect of the invention includes: a flat electrode assembly including a positive electrode and a negative electrode; a bottomed prismatic hollow outer can storing the flat electrode assembly and a nonaqueous electrolyte and having an opening portion; and a sealing plate sealing the opening portion of the hollow outer can. The flat electrode assembly has a portion, other than the side facing the sealing plate, covered with an insulating sheet. The nonaqueous electrolyte contains lithium difluorophosphate (LiPF₂O₂) at the time of making the nonaqueous electrolyte secondary battery. The outer surface area of a battery outer body including the bottomed prismatic hollow outer can and the sealing plate is 350 cm² or more.

When the outer surface area of a battery outer body including a bottomed prismatic hollow outer can and a sealing plate is large, 350 cm² or more, the external low temperature leads to the inside of a battery to have a low temperature. However, the nonaqueous electrolyte secondary battery of the invention uses a nonaqueous electrolyte containing LiPF₂O₂, thereby improving output characteristics in a low temperature environment. Moreover, a flat electrode assembly has a portion, other than the side facing the sealing plate, covered with an insulating sheet, and this insulating sheet serves as a heat insulating material. Therefore, the flat electrode assembly is less likely to be susceptible to the effect of the external low temperature, and the output characteristics in such a low temperature environment are further improved. The insulating sheet may have a box shape formed by bending one insulating sheet or a bag shape formed by folding one insulating sheet and bonding both lateral edges thereof.

A compound capable of reversibly absorbing and desorbing lithium ions may be selected to be used as appropriate as the positive electrode active material that can be used in the nonaqueous electrolyte secondary battery of the invention. Such electrode active materials include lithium transition-metal composite oxides that are represented by LiMO₂ (M is at least one of Co, Ni, and Mn) and are capable of reversibly absorbing and desorbing lithium ions, namely, LiCoO₂, LiNiO₂, LiNi_{y}Co_{1-y}O₂ (y=0.01 to 0.99), LiMnO₂, LiCoₓMn_{y}Ni_{z}O₂ (x+y+z=1), LiMn₂O₄, or LiFePo₄. Such lithium transition-metal composite oxides may be used alone, or two or more of them may be mixed to be used. Furthermore, lithium cobalt composite oxides with different metal element such as zirconium, magnesium, and aluminum added thereto may be used as well.

The following shows examples of a nonaqueous solvent that can be used for the nonaqueous electrolyte in the nonaqueous electrolyte secondary battery of the invention: a cyclic carbonate such as ethylene carbonate (EC), propylene carbonate (PC), and butylene carbonate (BC); a fluorinated cyclic carbonate; a cyclic carboxylic ester such as γ-butyrolactone (γ-BL) and γ-valerolactone (γ-VL); a chain carbonate such as dimethyl carbonate (DMC), ethyl methyl carbonate (EMC), diethyl carbonate (DEC), methylpropyl carbonate (MPC), and dibutyl carbonate (DBC); fluorinated chain carbonate; a chain carboxylic ester such as methyl pivalate, ethyl pivalate, methyl isobutyrate, and methyl propionate; an amide compound such as N, N′-dimethylformamide and N-methyl oxazolidinone; and a sulfur compound such as sulfolane. It is desirable that two or more of them be mixed to be used.

In the nonaqueous electrolyte secondary battery of the invention, the lithium salt that is commonly used as an electrolyte salt for an nonaqueous electrolyte secondary battery may be used as the electrolyte salt dissolved in the nonaqueous solvent. Examples of such a lithium salt are as follows: LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and mixtures of these substances. In particular, among them, it is preferable that LiPF₆ (lithium hexafluorophosphate) be used. The amount of dissolution of the electrolyte salt with respect to the nonaqueous solvent is preferably from 0.8 to 1.5 mol/L.

In the nonaqueous electrolyte secondary battery of the invention, LiPF₂O₂ is preferably contained in the nonaqueous electrolyte in an amount of 0.01 to 2.0 mol/L, more preferably 0.01 to 0.1 mol/L at the time of making the nonaqueous electrolyte secondary battery. In the nonaqueous electrolyte secondary battery of the invention, the additive amount of the LiPF₂O₂ in the nonaqueous electrolyte may be added as the electrolyte salt whose principal element is LiPF₂O₂. However, a large additive amount of LiPF₂O₂ in the nonaqueous electrolyte increases the viscosity of the nonaqueous electrolyte. Therefore, various electrolyte salts as above may be used as principal elements, and LiPF₂O₂ may be added as an additive substance in a small amount, for example, about 0.05 mol/L. When LiPF₂O₂ is added as the additive substance, depending on the additive amount thereof, all of the LiPF₂O₂ is consumed for forming the protective covering at the initial charge and discharge. This might lead to a case in which no LiPF₂O₂ is substantially in the nonaqueous electrolyte. The invention also includes this case. Thus, the invention includes any case in which the nonaqueous electrolyte of the nonaqueous electrolyte secondary battery before the initial charge contains LiPF₂O₂.

In the nonaqueous electrolyte secondary battery of the invention, it is preferable that the hollow outer can be made using aluminum or aluminum alloy and the insulating sheet be made using polyolefin. In such a case, it is preferable that the hollow outer can be made using pure aluminum and the sealing plate be made using aluminum alloy.

Polyolefin has excellent heat insulating properties and has smaller wettability to the nonaqueous electrolyte than aluminum or aluminum alloy (has a large contact angle). If the insulating sheet is of polyolefin and the hollow outer can is of aluminum or aluminum alloy, the wettability of the insulating sheet to the nonaqueous electrolyte is smaller than that of the hollow outer can to the nonaqueous electrolyte. This allows the nonaqueous electrolyte to easily penetrate the inside of the electrode assembly and provides a nonaqueous electrolyte secondary battery having excellent battery characteristics in a low temperature. The following may be adopted as the insulating sheet: an insulating sheet made using polypropylene, an insulating sheet made using polyethylene, an insulating sheet made using a mixture of polypropylene and polyethylene, or a multi-layer sheet of polypropylene and polyethylene. Using pure aluminum such as JIS-A1000 series (JIS-A1050, JIS-A1100, JIS-A1070, and JIS-A1085, for example) improves heat conductivity. Therefore, the effect of the invention is remarkably attained. JIS-A3003 and JIS-A3004, for example, are preferably used as aluminum alloy.

In the nonaqueous electrolyte secondary battery of the invention, the flat electrode assembly preferably has the outermost side thereof covered with a separator.

Such a structure is expected to further improve the heat insulating properties by the separator on the outermost side, thereby improving the battery characteristics in a low temperature environment.

In the nonaqueous electrolyte secondary battery of the invention, the thickness of the insulating sheet is preferably from 0.1 to 0.5 mm.

In the prismatic nonaqueous electrolyte secondary battery of the invention, more than 90% of the inner surface of the hollow outer can and the sealing plate preferably faces the insulating sheet.

In the nonaqueous electrolyte secondary battery of the invention, it is preferable that the flat electrode assembly be formed by winding an elongated positive electrode and an elongated negative electrode with an elongated separator interposed therebetween, that the flat electrode assembly include a positive electrode substrate exposed portion wound on one end and a negative electrode substrate exposed portion wound on the other end, that the wound positive electrode substrate exposed portion have both outermost sides thereof connected to a positive electrode collector, and that the wound negative electrode substrate exposed portion have both outermost sides thereof connected to a negative electrode collector.

Such a structure can provide a prismatic nonaqueous electrolyte secondary battery that has high capacity and high output characteristics. A low temperature environment leads to the inside of the electrode assembly to have a low temperature, and whereby the effect of the invention becomes more apparent.

It is preferable that the nonaqueous electrolyte containing a lithium salt having an oxalate complex as an anion be used to produce the nonaqueous electrolyte secondary battery of the invention. In such a case, the nonaqueous electrolyte preferably contains the lithium salt having the oxalate complex as an anion in an amount of 0.01 to 2.0 mol/L at the time of making the nonaqueous electrolyte secondary battery, more preferably from 0.05 to 0.2 mol/L.

The lithium salt having an oxalate complex as an anion added in the electrolyte is reacted with lithium at the initial charge to form a protective covering that is stable even in a high temperature on the surface of the negative electrode. This brings preferable cycling characteristics and provides a nonaqueous electrolyte secondary battery having excellent safety. The additive amount of the lithium salt having the oxalate complex as an anion in the nonaqueous electrolyte may be added as the electrolyte salt whose principal element is the lithium salt having the oxalate complex as an anion. However, a large additive amount of the lithium salt having the oxalate complex as an anion in the nonaqueous electrolyte increases the viscosity of the nonaqueous electrolyte. Therefore, various electrolyte salts as above may be used as principal elements, and the lithium salt having the oxalate complex as an anion may be added as an additive substance in a small amount.

When the lithium salt having the oxalate complex as an anion is added as the additive substance, depending on the additive amount thereof, all of the lithium salt having the oxalate complex as an anion is consumed for forming the protective covering at the initial charge. This might lead to a case in which no lithium salt having the oxalate complex as an anion is substantially in the nonaqueous electrolyte. The invention also includes this case.

In the nonaqueous electrolyte secondary battery of the invention, it is preferable that the lithium salt having the oxalate complex as an anion be lithium bis(oxalato)borate (Li[B(C₂O₄)₂], hereinafter referred to as “LiBOB”).

Using LiBOB as the lithium salt having the oxalate complex as an anion provides the nonaqueous electrolyte secondary battery capable of attaining further preferable cycling characteristics.

### BRIEF DESCRIPTION OF THE DRAWINGS

The invention will be described with reference to the accompanying drawings, wherein like numbers reference like elements.

FIG. 1A is a plan view of a prismatic nonaqueous electrolyte secondary battery in accordance with an embodiment. FIG. 1B is a front view thereof.

FIG. 2A is a fragmentary sectional view along line IIA-IIA of FIG. 1A. FIG. 2B is a fragmentary sectional view along line IIB-IIB of FIG. 2A. FIG. 2C is a sectional view along line IIC-IIC of FIG. 2A.

FIG. 3A is a plan view of a positive electrode used in the prismatic nonaqueous electrolyte secondary battery in accordance with the embodiment. FIG. 3B is a plan view of a negative electrode thereof.

FIG. 4 is a fragmentary enlarged sectional view along line IV-IV of FIG. 2B.

FIG. 5 is a view illustrating a state of inserting a flat winding electrode assembly into an assembled insulating sheet.

FIG. 6A is a fragmentary sectional view of a prismatic nonaqueous electrolyte secondary battery in accordance with a modification corresponding to FIG. 2A. FIG. 6B is a sectional view along line VIB-VIB of FIG. 6A.

### DESCRIPTION OF EXEMPLARY EMBODIMENTS

Various embodiments of the invention will be described below in detail with reference to the accompanying drawings. However, the embodiments described below are merely illustrative examples for understanding the technical spirit of the invention and are not intended to limit the invention to the embodiments. The invention may be equally applied to various modifications without departing from the technical spirit described in the claims. A flat electrode assembly to be used in the invention may be applied to a flat electrode assembly that has a plurality of layers of a positive electrode substrate exposed portion formed on one end and a plurality of layers of a negative electrode substrate exposed portion formed on the other end by stacking or winding a positive electrode and a negative electrode with a separator interposed therebetween. The following will describe an example of a flat winding electrode assembly.

### Embodiment

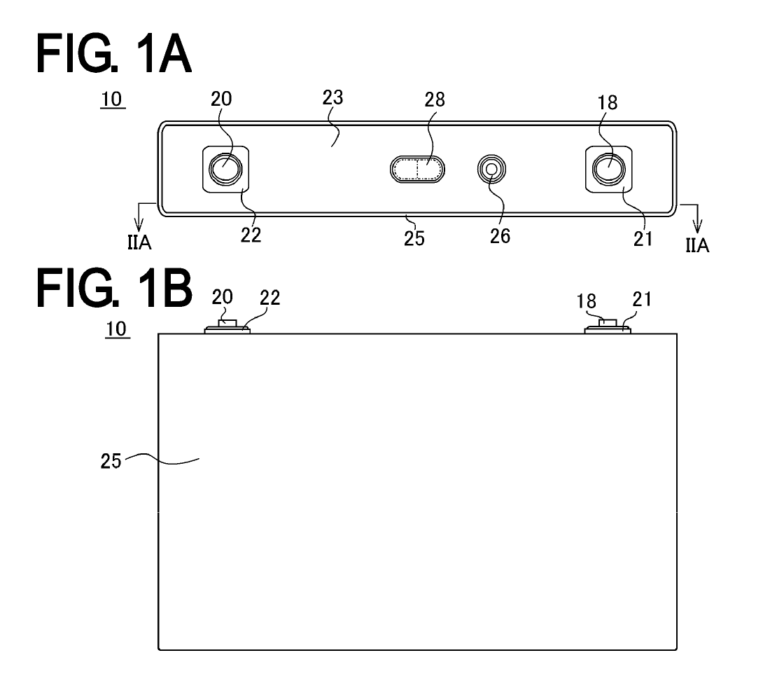

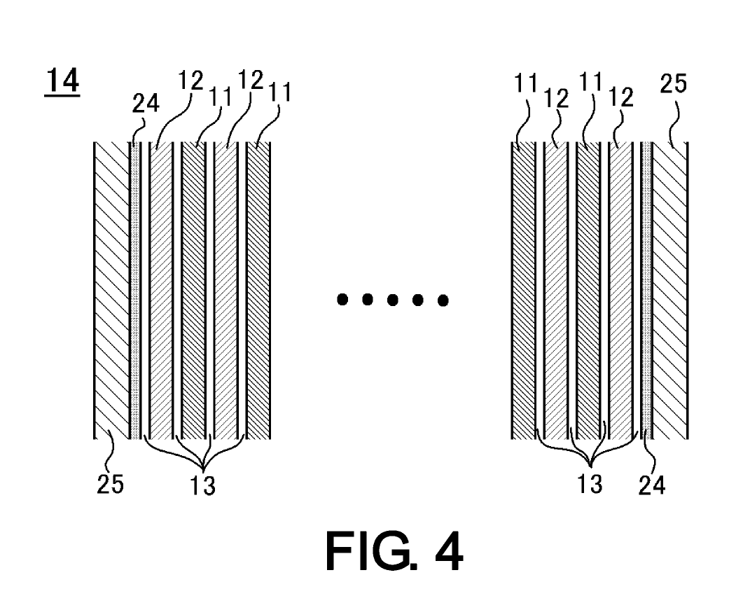

First, a prismatic nonaqueous electrolyte secondary battery in accordance with Embodiment 1 will be described with reference to FIGS. 1 to 4. As shown in FIG. 4, this nonaqueous electrolyte secondary battery 10 includes a flat winding electrode assembly 14. In the electrode assembly 14, a positive electrode 11 and a negative electrode 12 are wound while being insulated from each other with a separator 13 interposed therebetween. The winding electrode assembly 14 has its outermost side covered with the separator 13 and has the negative electrode 12 disposed on a further outer side than the positive electrode 11.

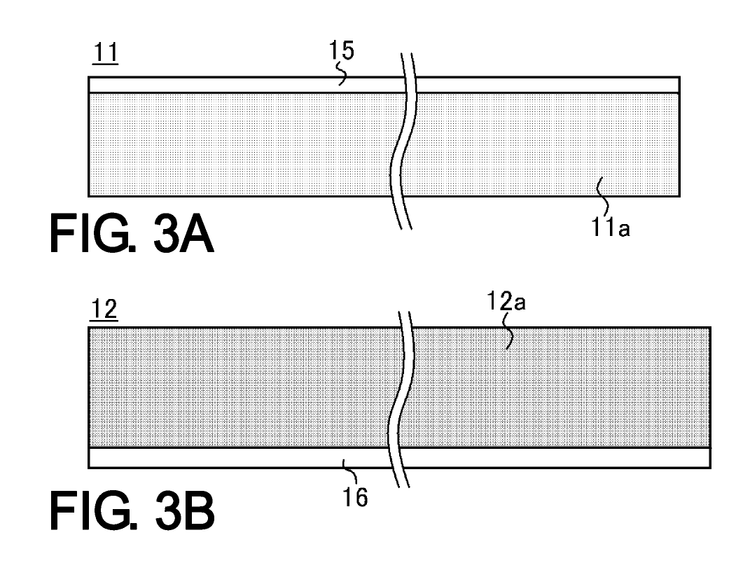

As illustrated in FIG. 3A, a positive electrode 11 is produced by the following process: a positive electrode active material mixture is applied onto both sides of a positive electrode substrate of aluminum foil; the resultant object is dried and extended by applying pressure; and the positive electrode 11 is slit so as to expose the aluminum foil in a strip along the end of one side in the wide direction. The part of the aluminum foil exposed in a strip is a positive electrode substrate exposed portion 15.

As illustrate in FIG. 3B, a negative electrode 12 is produced by the following process: a negative electrode active material mixture is applied onto both sides of a negative electrode substrate of copper foil; the resultant object is dried and extended by applying pressure; and the negative electrode 12 is slit so as to expose the copper foil in a strip along the end of one side in the wide direction. The part of the copper foil exposed in a strip is a negative electrode substrate exposed portion 16.

The width and length of a negative electrode active material mixture layer 12a of the negative electrode 12 are larger than those of a positive electrode active material mixture layer 11a. It is preferable that the positive electrode substrate be formed using foil of aluminum or aluminum alloy having a thickness of about from 10 to 20 μm, while the negative electrode substrate be formed using foil of copper or copper alloy having a thickness of about from 5 to 15 μm. A specific composition of the positive electrode active material mixture layer 11a and the negative electrode active material mixture layer 12a will be described later.

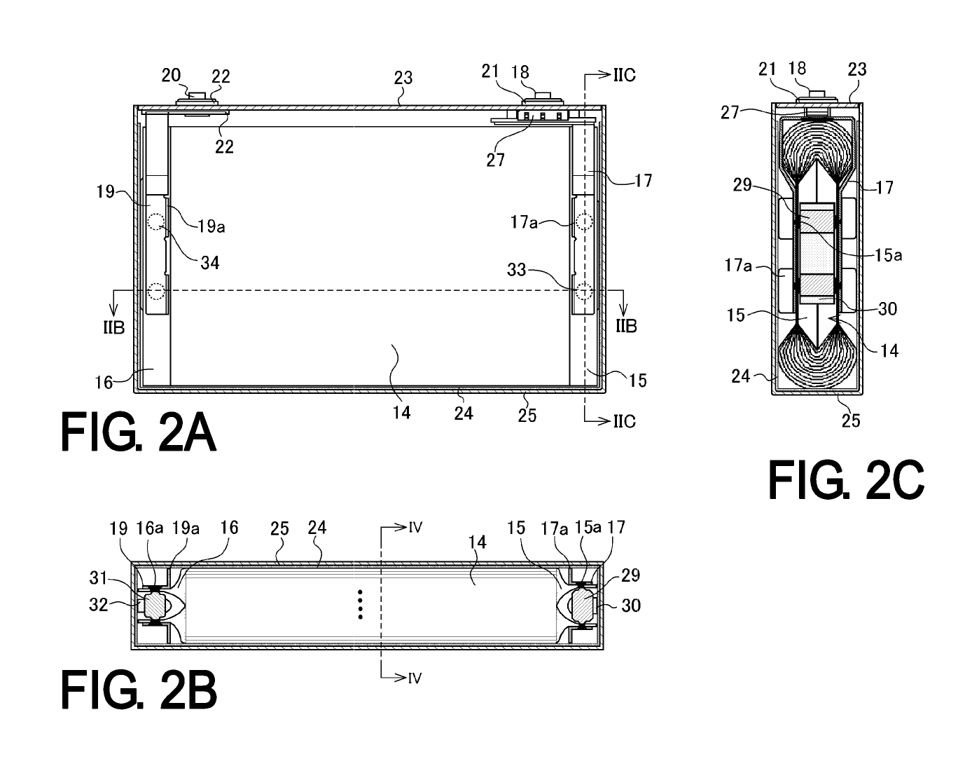

As shown in FIGS. 2A and 2B, the flat winding electrode assembly 14 having a plurality of stacked layers of the positive electrode substrate exposed portion 15 on one end and a plurality of stacked layers of the negative electrode substrate exposed portion 16 on the other end is produced by the following process: the positive electrode 11 and the negative electrode 12 produced as above are displaced so that the aluminum foil exposed portion of the positive electrode 11 and the copper foil exposed portion of the negative electrode 12 are not overlapped by the active material mixture layers of the opposing electrodes; and the positive electrode 11 and the negative electrode 12 are wound while being insulated from each other with a separator 13 interposed therebetween. A microporous polyolefin membrane is preferably used as the separator 13.

The stacked layers of the positive electrode substrate exposed portion 15 are electrically connected to a positive electrode terminal 18 of aluminum material with a positive electrode collector 17 of aluminum material interposed therebetween. Likewise, the stacked layers of the negative electrode substrate exposed portion 16 are electrically connected to a negative electrode terminal 20 of copper material with a negative electrode collector 19 of copper material interposed therebetween. As shown in FIGS. 1A, 1B, and 2A, the positive electrode terminal 18 and the negative electrode terminal 20 are fixed to a sealing plate 23 of aluminum material or other material with insulating members 21 and 22, respectively, interposed therebetween. Where appropriate, the positive electrode terminal 18 and the negative electrode terminal 20 are connected to an external positive electrode terminal and an external negative electrode terminal (neither shown in the drawings), respectively.

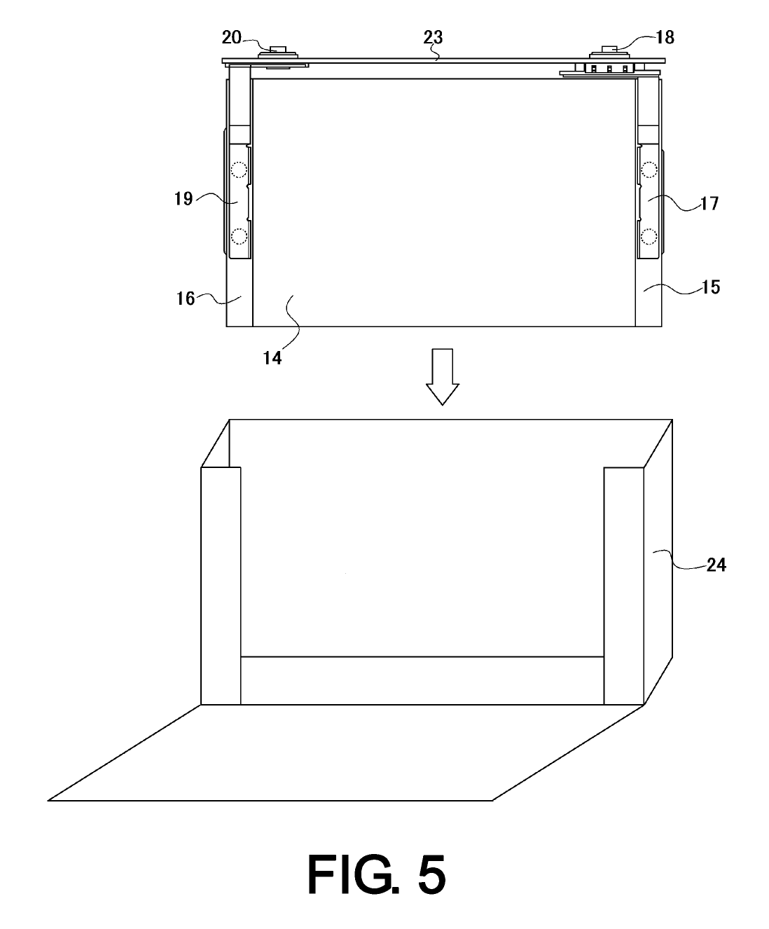

As described above, the flat winding electrode assembly 14 is formed by attaching the positive electrode collector 17 and the negative electrode collector 19 to the positive electrode terminal 18 and the negative electrode terminal 20 that are provided to the sealing plate 23, respectively. As shown in FIG. 5, the flat winding electrode assembly 14 is inserted into an insulating sheet 24. The insulating sheet 24 of polypropylene, for example, is assembled in a box-shape so that the mouth is positioned on the sealing plate 23 side. Thus, the flat winding electrode assembly 14 other than the sealing plate 23 side is covered with the insulating sheet 24, and the flat winding electrode assembly 14 together with this insulating sheet 24 is inserted into a hollow outer can 25 of pure aluminum (JIS A1000) having one side thereof open. The sealing plate 23 is then fitted to an opening portion of the hollow outer can 25, and a fitting portion between the sealing plate 23 and the hollow outer can 25 is laser-welded. Moreover, a nonaqueous electrolyte is poured through an electrolyte pour hole 26, and then the electrolyte pour hole 26 is sealed. Consequently, the nonaqueous electrolyte secondary battery 10 of Embodiment 1 is produced. In the prismatic nonaqueous electrolyte secondary battery 10 of the embodiment, as shown in FIG. 4, starting from the hollow outer can 25, the insulating sheet 24, the separator 13, the negative electrode 12, the separator 13, the positive electrode 11, the separator 13, the negative electrode 12, . . . are disposed.

A current interruption mechanism 27 operated by a gas pressure generated inside the battery is provided between the positive electrode collector 17 and the positive electrode terminal 18. A gas exhaust valve 28 that is open when a gas pressure higher than the working pressure of the current interruption mechanism 27 is applied is also provided on the sealing plate 23. Therefore, the inside of the nonaqueous electrolyte secondary battery 10 is sealed. The nonaqueous electrolyte secondary battery 10 alone may be used, or a plurality of nonaqueous electrolyte secondary batteries 10 connected in series or in parallel may be used for various purposes. When a plurality of nonaqueous electrolyte secondary batteries 10 connected in series or in parallel are used, the external positive electrode terminal and the external negative electrode terminal may be provided separately to connect the respective batteries with a bus bar.

The flat winding electrode assembly 14 used in the prismatic nonaqueous electrolyte secondary battery 10 of the embodiment is used when high capacity of 20 Ah or more and high output characteristics are required. For example, the winding number of the positive electrode 11 is 43, in other words, the total number of stacked layers of the positive electrode 11 is 86. When the winding number is 30 or more, in other words, the total number of stacked layers is 60 or more, the capacity of the battery can be 20 Ah or more without increasing the size of the battery beyond necessity.

When the total number of stacked layers of the positive electrode substrate exposed portion 15 or the negative electrode substrate exposed portion 16 is large, a large amount of welding current is needed to form a weld mark 15a or 16a passing through the whole stacked layer portions of the stacked positive electrode substrate exposed portion 15 or the negative electrode substrate exposed portion 16 in resistance-welding the positive electrode collector 17 and the negative electrode collector 19 to the positive electrode substrate exposed portion 15 and the negative electrode substrate exposed portion 16, respectively.

As shown in FIGS. 2A to 2C, in the positive electrode 11, the stacked positive electrode substrate exposed portion 15 is divided into two segments, and a positive electrode intermediate member 30 is interposed therebetween. The positive electrode intermediate member 30 is formed using a resin member and holds a plurality of positive electrode conductive members 29, here, two positive electrode conductive members 29. Likewise, in the negative electrode 12, the stacked positive electrode substrate exposed portion 16 is divided into two segments, and a negative electrode intermediate member 32 is interposed therebetween. The negative electrode intermediate member 32 is formed using a resin member and holds a plurality of negative electrode conductive members 31, here, two negative electrode conductive members 31. The positive electrode collector 17 is disposed on the surfaces of both sides of the outermost side of the two segments of the positive electrode substrate exposed portion 15 that are disposed on both sides of the positive electrode conductive members 29. The negative electrode collector 19 is disposed on the surfaces of both sides of the outermost side of the two segments of the negative electrode substrate exposed portion 16 that are disposed on both sides of the negative electrode conductive members 31. The positive electrode conductive members 29 are made of aluminum material as with the positive electrode substrate, and the negative electrode conductive members 31 are made of copper material as with the negative electrode substrate. The shape of the positive electrode conductive members 29 and the negative electrode conductive members 31 may be either the same or different.

When the positive electrode substrate exposed portion 15 or the negative electrode substrate exposed portion 16 is divided into two segments, welding current needed to form a weld mark 15a or 16a passing through the whole stacked layer portion of the stacked positive electrode substrate exposed portion 15 or the negative electrode substrate exposed portion 16 is small compared to a case in which there is no division. This prevents sputters during resistance welding, thereby preventing a trouble such as an internal short in the winding electrode assembly 14 due to the sputters. Thus, the resistance welding is performed between the positive electrode collector 17 and the positive electrode substrate exposed portion 15 and between the positive electrode substrate exposed portion 15 and the positive electrode conductive members 29. Resistance welding is also performed between the negative electrode collector 19 and the negative electrode substrate exposed portion 16 and between the negative electrode substrate exposed portion 16 and the negative electrode conductive members 31. FIG. 2 shows two weld marks 33 formed by resistance-welding in the positive electrode collector 17 and two weld marks 34 formed by resistance-welding in the negative electrode collector 19.

The resistance-welding methods with the positive electrode intermediate member 30 including the positive electrode substrate exposed portion 15, the positive electrode collector 17, and the positive electrode conductive members 29, and with the negative electrode intermediate member 32 including the negative electrode substrate exposed portion 16, the negative electrode collector 19, and the negative electrode conductive members 31 in the flat winding electrode assembly 14 of the embodiment will be described in detail below. In the embodiment, the shapes of the positive electrode conductive members 29 and the negative electrode conductive members 31 may be substantially the same, and the shapes of the positive electrode intermediate member 30 and the negative electrode intermediate member 32 may be substantially the same. The resistance-welding methods are substantially the same as well. Therefore, the positive electrode 11 will be described below as an example.

The positive electrode substrate exposed portion 15 of the flat winding electrode assembly 14 produced as above is divided into two segments from the winding central part to both sides and is collected centering on a quarter of the thickness of the electrode assembly. Subsequently, the positive electrode collector 17 is provided on both surfaces on the outermost periphery side of the positive electrode substrate exposed portion 15. On the inner periphery side of the positive electrode substrate exposed portion 15, the positive electrode intermediate member 30 including the positive electrode conductive members 29 is inserted between the two segments of the positive electrode substrate exposed portion 15 so that respective projections on both sides of the positive electrode conductive members 29 are brought into contact with the positive electrode substrate exposed portion 15. For example, the positive electrode collector 17 is made of an aluminum plate that has a thickness of 0.8 mm.

The positive electrode conductive members 29 held by the positive electrode intermediate member 30 of the embodiment have projections that have, for example, a shape of a circular truncated cone and are formed on two surfaces facing each other on the cylindrical main body. As long as the positive electrode conductive members 29 are made of metal and blockish, any shape such as a cylinder, a prism, and an elliptic cylinder may be adopted. Materials made of copper, copper alloy, aluminum, aluminum alloy, tungsten, molybdenum, etc., may be used as a formation material of the positive electrode conductive members 29. Among the materials made of these metals, the following configurations may be adopted: the projection on which nickel plate is applied; and the projection and its base area formed of metal material that facilitates heat generation such as tungsten and molybdenum and, for example, brazed to the main body of the cylindrical positive electrode conductive members 29 made of copper, copper alloy, aluminum or aluminum alloy.

A plurality of, for example, here two pieces of positive electrode conductive members 29 are integrally held by the positive electrode intermediate member 30. In such a case, the respective electrode conductive members 29 are held so as to be in parallel with each other. The positive electrode intermediate member 30 may have any shape such as a prism and cylinder. However, a landscape prism is desirable in order that the positive electrode intermediate member 30 is stably positioned and fixed between the two segments of the positive electrode substrate exposed portion 15. It is preferable that the corners of the positive electrode intermediate member 30 be chamfered in order not to hurt or deform the soft positive electrode substrate exposed portion 15 even if contacting the positive electrode substrate exposed portion 15. At least a part to be inserted between the two segments of the positive electrode substrate exposed portion 15 may be chamfered.

The length of the prismatic positive electrode intermediate member 30 varies depending on the size of the prismatic nonaqueous electrolyte secondary battery 10, but it may be from 20 mm to tens of mm. The width of the prismatic positive electrode intermediate member 30 may be as much as the height of the positive electrode conductive members 29, but at least both ends of the positive electrode conductive members 29 as welded portions may be exposed. It is preferable that both ends of the positive electrode conductive members 29 protrude from the surface of the positive electrode intermediate member 30, but the positive electrode conductive members 29 do not necessarily protrude. Such a structure enables the positive electrode conductive members 29 to be held in the positive electrode intermediate member 30, and the positive electrode intermediate member 30 to be stably positioned and disposed between the two segments of the positive electrode substrate exposed portion 15.

Subsequently, the flat winding electrode assembly 14, which includes the positive electrode collector 17 and the positive electrode intermediate member 30 holding the positive electrode conductive members 29 disposed therein, is arranged between a pair of resistance welding electrodes (not shown in the drawings). The pair of resistance welding electrodes are each brought into contact with the positive electrode collector 17 disposed on both surfaces of the outermost periphery side of the positive electrode substrate exposed portion 15. An appropriate pressure is then applied between the pair of resistance welding electrodes, thereby performing the resistance welding under predetermined certain conditions. In this resistance welding, the positive electrode intermediate member 30 is stably positioned and disposed between the two segments of the positive electrode substrate exposed portion 15, which improves the dimensional accuracy between the positive electrode conductive members 29 and the pair of resistance welding electrodes, enables the resistance welding to be performed in an accurate and stable state, and curbs variation in the welding strength.

Next, the detailed structure of the positive electrode collector 17 and the negative electrode collector 19 of the embodiment will be described with reference to FIG. 2. As shown in FIGS. 2A and 2B, the positive electrode collector 17 is electrically connected to a plurality of layers of the positive electrode substrate exposed portion 15 stacked on one side edge of the flat winding electrode assembly 14 by the resistance welding method. The positive electrode collector 17 is electrically connected to the positive electrode terminal 18. Likewise, the negative electrode collector 19 is electrically connected to a plurality of layers of the negative electrode substrate exposed portion 16 stacked on the other side edge of the flat winding electrode assembly 14 by the resistance welding method. The negative electrode collector 19 is electrically connected to the negative electrode terminal 20.

The positive electrode collector 17 is produced, for example, by punching out an aluminum plate in a particular shape and bending it. The positive electrode collector 17 has a rib 17a formed on its main body part where the resistance welding is performed with a bundle of the positive electrode substrate exposed portion 15. The negative electrode collector 19 is produced, for example, by punching out a copper plate in a particular shape and bending it. The negative electrode collector 19 also has a rib 19a formed on its main body part where the resistance welding is performed with a bundle of the negative electrode substrate exposed portion 16.

The rib 17a of the positive electrode collector 17 and the rib 19a of the negative electrode collector 19 serve as a shield in order to prevent sputters generated during the resistance welding from entering the inside of the flat winding electrode assembly 14, and as a radiation fin in order to prevent a portion other than the resistance welded portion of the positive electrode collector 17 and the negative electrode collector 19 from being melted by heat generated during the resistance welding. The ribs 17a and 19a are provided at a right angle from the main body of the positive electrode collector 17 and the negative electrode collector 19, respectively, but the angle need not necessarily be vertical. Even a tilt of about ±10° from the right angle brings the same function effect.

In the prismatic nonaqueous electrolyte secondary battery 10 of the embodiment, the example shows that two ribs are provided corresponding to the resistance welding position along the longitudinal direction as the rib 17a of the positive electrode collector 17 and the rib 19a of the negative electrode collector 19. However, the configuration is not limited to this case. One rib may be provided, or ribs may be formed on both sides in the width direction. When ribs are formed on both sides in the width direction, their heights may be either the same or different. If their heights are different, it is preferable that the rib around the flat winding electrode assembly 14 be provided at a higher position than the other.

Preparation of Positive Electrode

The following describes a specific composition of the positive electrode active material mixture layer 11a and the negative electrode active material mixture layer 12a and a specific composition of the nonaqueous electrolyte used in the prismatic nonaqueous electrolyte secondary battery 10 of the embodiment. Lithium nickel cobalt manganese composite oxide represented by LiNi_{0.35}Co_{0.35}Mn_{0.30}O₂ was used as the positive electrode active material. This lithium nickel cobalt manganese composite oxide, carbon powder as a conductive agent, and polyvinylidene fluoride (PVdF) as a binding agent were weighed so that the mass ratio would be 88:9:3, and were mixed with N-methyl-2-pyrrolidone (NMP) as dispersion media to produce a positive electrode active material mixture slurry. This positive electrode active material mixture slurry was applied with a die coater onto both sides of the positive electrode substrate of aluminum foil whose thickness was, for example, 15 μm to form the positive electrode active material mixture layer onto both sides of the positive electrode substrate. Next, the resultant object was dried to remove NMP as an organic solvent, and was pressed with a roll press to have a particular thickness. The electrode thus obtained was slit in a particular width on one end of the electrode in the width direction along the whole longitudinal direction to form the positive electrode substrate exposed portion 15 that had no positive electrode active material mixture layer formed onto both sides, and whereby the positive electrode 11 of the structure shown in FIG. 3A was obtained.

Preparation of Negative Electrode

The negative electrode was produced as follows: 98 parts by mass of graphite powder, 1 part by mass of carboxymethylcellulose (CMC) as a thickening agent, and 1 part by mass of styrene-butadiene-rubber (SBR) as a binding agent were dispersed in water to produce a negative electrode active material mixture slurry. This negative electrode active material mixture slurry was applied with a die coater onto both sides of the negative electrode collector of copper foil whose thickness was 10 μm, and was dried to form the negative electrode active material mixture layer onto both sides of the negative electrode collector. Next, the resultant object was pressed with a press roller to have a particular thickness. The electrode thus obtained was slit in a particular width on one end of the electrode in the width direction along the whole longitudinal direction to form the negative electrode substrate exposed portion 16 that had no negative electrode active material mixture layer formed onto both sides, and whereby the negative electrode 12 of the structure shown in FIG. 3B was obtained.

Preparation of Nonaqueous Electrolyte

The nonaqueous electrolyte to be used was produced as follows: as a solvent, ethylene carbonate (EC) and methyl ethyl carbonate (MEC) were mixed with a volume ratio (25° C. and 1 atmosphere) of 3:7; LiPF₆ as an electrolyte salt was added to the mixed solvent so that the concentration would be 1 mol/L; and then LiPF₂O₂ was further added so that the concentration would be 0.05 mol/L. LiPF₂O₂ causes a protective covering to be formed on the surface of the positive electrode and the negative electrode at the initial charge and discharge. Therefore, in the prismatic nonaqueous electrolyte secondary battery 10 of the embodiment, all LiPF₂O₂ added to the nonaqueous electrolyte is not necessarily present in the form of LiPF₂O₂.

Production of Prismatic Nonaqueous Electrolyte Secondary Battery

The negative electrode 12 and the positive electrode 11 produced as above were wound while being insulated from each other with the separator 13 interposed therebetween so as to dispose the negative electrode 12 onto the outermost periphery side. Subsequently, the resultant object was formed to be flat, and whereby the flat winding electrode assembly 14 was produced. The negative electrode 12 on the outermost side has the surface thereof covered with the separator 13. In the flat winding electrode assembly 14, the winding numbers of the positive electrode 11 and the negative electrode 12 were 43 and 44, respectively, in other words, the numbers of stacked layers of the positive electrode 11 and the negative electrode 12 were 86 and 88, respectively, and the design capacity was 20 Ah. Furthermore, the total numbers of stacked layers of the positive electrode substrate exposed portion 15 and the negative electrode substrate exposed portion 16 were 86 and 88, respectively. As shown in FIGS. 1, 2, and 5, this flat winding electrode assembly 14 was used, and a positive electrode collector 17 and a negative electrode collector 19 were welded and connected to the positive electrode substrate exposed portion 15 and the negative electrode substrate exposed portion 16, respectively, by resistance-welding. It is preferable that the positive electrode collector 17 be electrically connected in advance to a positive electrode terminal 18 with a current interruption mechanism 27 interposed therebetween and that the positive electrode collector 17, the current interruption mechanism 27, and the positive electrode terminal 18 be attached to the sealing plate 23 in a state of being electrically insulated from each other, before connecting the positive and negative electrode collectors to the positive and negative electrode substrate exposed portions. In addition, it is preferable that the negative electrode collector 19 be electrically connected in advance to a negative electrode terminal 20 and that the negative electrode collector 19 and the negative electrode terminal 20 be attached to the sealing plate 23 in a state of being electrically insulated from each other.

As described above, the flat winding electrode assembly 14 was formed by attaching the positive electrode collector 17 and the negative electrode collector 19 to the positive electrode terminal 18 and the negative electrode terminal 20 that were provided to the sealing plate 23, respectively. As shown in FIG. 5, the flat winding electrode assembly 14 was inserted into an insulating sheet 24. The insulating sheet 24, for example, having a thickness of 0.2 mm and made using polypropylene, was assembled in a box shape so that the mouth was positioned on the sealing plate 23 side. Consequently, the flat winding electrode assembly 14 other than the sealing plate 23 side was covered with an insulating sheet 24. Next, the flat winding electrode assembly 14 covered with this insulating sheet 24 was inserted into a hollow outer can 25 of pure aluminum metal having one side thereof open. Subsequently, the sealing plate 23 was fitted to an opening portion of the hollow outer can 25, and a fitting portion between the sealing plate 23 and the hollow outer can 25 was laser-welded. Moreover, the above-mentioned nonaqueous electrolyte was poured into the hollow outer can 25, thereby producing the prismatic nonaqueous electrolyte secondary battery of the embodiment having a structure described in FIGS. 1 and 2. In the prismatic nonaqueous electrolyte secondary battery 10 of this embodiment, the proportion of a portion where the inner surfaces of the hollow outer can 25 and the sealing plate 23 face the insulating sheet 24 was set to 92% of all of the inner surfaces of the hollow outer can 25 and the sealing plate 23. The produced prismatic nonaqueous electrolyte secondary battery of the embodiment has a size of a width of 2.6 cm×a length of 15 cm×a height of 9.1 cm. The outer surface area of a battery outer body including the hollow outer can 25 and the sealing plate 23 is approximately 400 cm².

The prismatic nonaqueous electrolyte secondary battery of the embodiment can provide a nonaqueous electrolyte secondary battery that has excellent output characteristics in a low temperature environment.

Modification

The nonaqueous electrolyte secondary battery 10 of the embodiment shows an example in which the stacked layers of the positive electrode substrate exposed portion 15 and the stacked layers of the negative electrode substrate exposed portion 16 are divided into two segments to interpose therebetween the positive electrode intermediate member 30 including the positive electrode conductive member 29 and the negative electrode intermediate member 32 including the negative electrode conductive member 31, respectively. However, in the invention, it is not necessary to divide the stacked layers of the positive electrode substrate exposed portion 15 or the stacked layers of the negative electrode substrate exposed portion 16 into two segments.

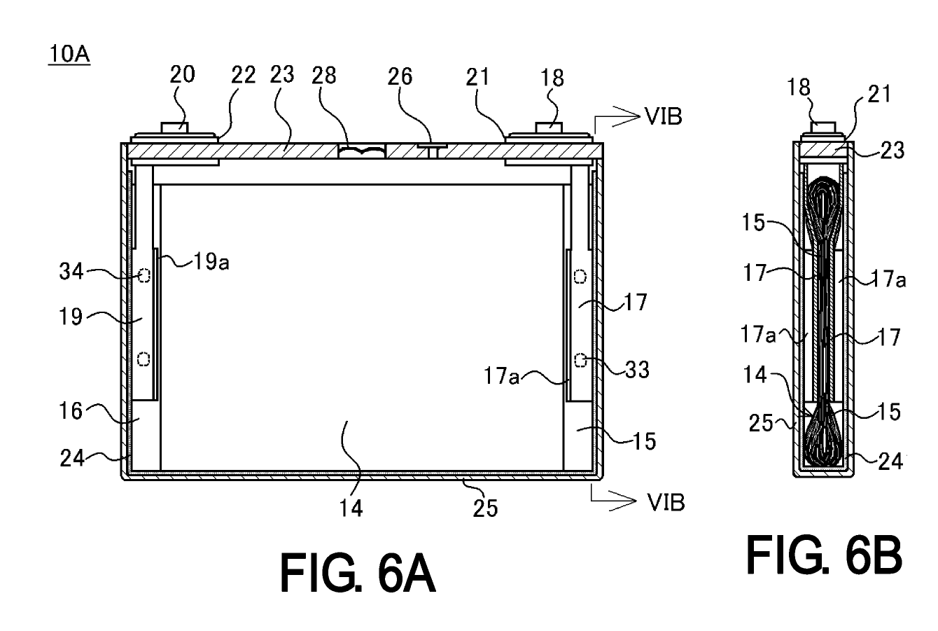

A prismatic nonaqueous electrolyte secondary battery 10A in accordance with a modification will be described with reference to FIG. 6, in which neither stacked layers of the positive electrode substrate exposed portion 15 nor stacked layers of the negative electrode substrate exposed portion 16 are divided into two segments and neither a positive electrode conductive member nor a negative electrode conductive member is used. In FIG. 6, like numbers are given to like components corresponding to the prismatic nonaqueous electrolyte secondary battery 10 of the embodiment shown in FIG. 2, and the detailed description thereof is omitted. In the flat winding electrode assembly 14 of the modification, a resistance welded portion between the positive electrode substrate exposed portion 15 and a positive electrode collector 17 and a resistance welded portion between the negative electrode substrate exposed portion 16 and a negative electrode collector 19 are different in formation material but are substantially similar in structure. Thus, FIG. 6B shows a side view of the positive electrode substrate exposed portion 15 as an example, and a side view of the negative electrode substrate exposed portion 16 is not shown.

In the flat winding electrode assembly 14 used in the prismatic nonaqueous electrolyte secondary battery 10A of the modification, the amounts per unit area of a positive electrode active material mixture layer 11a of the positive electrode 11 and a negative electrode active material mixture layer 12a of the negative electrode 12 are larger than those in the embodiment. The winding number of the positive electrode 11 and the negative electrode 12 are 35 and 36, respectively. In other words, the total numbers of stacking layers of the positive electrode 11 and the negative electrode 12 are 70 and 72, respectively. The design capacity is 25 Ah. Furthermore, the total numbers of stacking layers of the positive electrode substrate exposed portion 15 and the negative electrode substrate exposed portion 16 are 70 and 72, respectively. On the positive electrode 11 side, the positive electrode collector 17 is disposed on the surfaces of both sides of the outermost side of the stacked layers of the positive electrode substrate exposed portion 15. On the negative electrode 12 side, the negative electrode collector 19 is disposed on the surfaces of both sides of the outermost side of the stacked layers of the negative electrode substrate exposed portion 16. The resistance welding is performed at two points so that weld marks (not shown in the drawings) are formed so as to pass through the whole stacked layer portions of the stacked positive electrode substrate exposed portion 15 or the stacked negative electrode substrate exposed portion 16. FIG. 6 shows the weld mark 33 formed at two points in the positive electrode collector 17 by resistance-welding and the weld mark 34 formed at two points in the negative electrode collector 19 by resistance-welding.

In the flat winding electrode assembly 14 used in the prismatic nonaqueous electrolyte secondary battery 10A of the modification, the rib 17a formed onto the positive electrode collector 17 and the rib 19a formed onto the negative electrode collector 19 are formed across the two resistance welding points.

In the prismatic nonaqueous electrolyte secondary batteries 10 and 10A of the above-mentioned embodiment and modification, LiPF₂O₂ is added to the nonaqueous electrolyte. However, it is preferable that a lithium salt having an oxalate complex as an anion be also added to the nonaqueous electrolyte.

In addition to LiBOB, lithium difluoro(oxalato)borate, lithium tris(oxalato)phosphate, lithium difluoro(bisoxalato)phosphate, lithium tetrafluoro(oxalato)phosphate are known as the lithium salt having a oxalate complex as an anion in the nonaqueous electrolyte. In particular, using LiBOB can provide a nonaqueous electrolyte secondary battery that has further excellent cycling characteristics.

The nonaqueous electrolyte secondary battery of the embodiment and modification shows an example in which the integrated positive electrode collector 17 or the integrated negative electrode collector 19 are connected to both of the outermost sides of the positive electrode substrate exposed portion 15 or both of the outermost side of the negative electrode substrate exposed portion 16. However, the positive electrode collector 17 or the negative electrode collector 19 may be connected to only one side of the outer utmost sides of the positive electrode substrate exposed portion 15 or of the outermost sides of the negative electrode substrate exposed portion 16, and a mere collector receiving member may be disposed on the other side. The nonaqueous electrolyte secondary batteries of the embodiment and the modification show an example of connecting between the positive electrode substrate exposed portion 15 and the positive electrode collector 17 and between the negative electrode substrate exposed portion 16 and the negative electrode collector 19 by resistance-welding, but the connection can be made by ultrasonic welding or irradiation of high-energy rays such as a laser. Furthermore, different connections may be made on the positive electrode side and the negative electrode side.

1. A nonaqueous electrolyte secondary battery comprising:
a flat electrode assembly including a positive electrode and a negative electrode;
a bottomed prismatic hollow outer can storing the flat electrode assembly and a nonaqueous electrolyte and having an opening portion; and
a sealing plate sealing the opening portion of the hollow outer can, the flat electrode assembly having a portion, other than the side facing the sealing plate, covered with an insulating sheet,
the nonaqueous electrolyte containing lithium difluorophosphate (LiPF₂O₂) at the time of making the nonaqueous electrolyte secondary battery, and
the outer surface area of a battery outer body including the hollow outer can and the sealing plate being 350 cm² or more.

2. The nonaqueous electrolyte secondary battery according to claim 1, wherein
the hollow outer can is made using aluminum or aluminum alloy, and
the insulating sheet is made using polyolefin.

3. The nonaqueous electrolyte secondary battery according to claim 1, wherein
the hollow outer can is made using pure aluminum, and
the sealing plate is made using aluminum alloy.

4. The nonaqueous electrolyte secondary battery according to claim 1, wherein
the flat electrode assembly has the outermost side thereof covered with a separator.

5. The nonaqueous electrolyte secondary battery according to claim 1, wherein
the thickness of the insulating sheet is from 0.1 to 0.5 mm.

6. The nonaqueous electrolyte secondary battery according to claim 1, wherein
more than 90% of the inner surface of the hollow outer can and the sealing plate faces the insulating sheet.

7. The nonaqueous electrolyte secondary battery according to claim 1, wherein
the flat electrode assembly is formed by winding the elongated positive electrode and the elongated negative electrode with the elongated separator interposed therebetween, the flat electrode assembly includes a positive electrode substrate exposed portion wound on one end and a negative electrode substrate exposed portion wound on the other end, the wound positive electrode substrate exposed portion has both outermost sides thereof connected to a positive electrode collector, and the wound negative electrode substrate exposed portion has both outermost sides thereof connected to a negative electrode collector.

8. The nonaqueous electrolyte secondary battery according to claim 1, wherein
the lithium difluorophosphate is contained in an amount of 0.01 to 2.0 mol/L at the time of making the nonaqueous electrolyte secondary battery.

9. The nonaqueous electrolyte secondary battery according to claim 1, wherein
the nonaqueous electrolyte contains a lithium salt having an oxalate complex as an anion at the time of making the nonaqueous electrolyte secondary battery.

10. The nonaqueous electrolyte secondary battery according to claim 9, wherein
the lithium salt having the oxalate complex as an anion is contained in an amount of 0.01 to 2.0 mol/L at the time of making the nonaqueous electrolyte secondary battery.

11. The nonaqueous electrolyte secondary battery according to claim 9, wherein
the lithium salt having the oxalate complex as an anion is lithium bis(oxalato)borate (Li[B(C₂O₄)₂]).

12. The nonaqueous electrolyte secondary battery according to claim 1, wherein
the nonaqueous electrolyte contains lithium difluorophosphate (LiPF₂O₂).

13. The nonaqueous electrolyte secondary battery according to claim 9, wherein
the nonaqueous electrolyte contains a lithium salt having an oxalate complex as an anion.
